(19) United States
(12) Patent Application Publication
(10) Pub. No.: US 2004/0187467 A1
(43) Pub. Date: Sep. 30, 2004

(54) Field coring apparatus and method

(76) Inventors: Jose Luis Garcia JR., Yuma, AZ (US); Carlos Alonzo, Yuma, AZ (US); Frank J. Maconachy, Salinas, CA (US)

Correspondence Address: WEISS & MOY PC, 4204 NORTH BROWN AVENUE, SCOTTSDALE, AZ, 85251, US

(21) Appl. No.: 10/653,395

(22) Filed: Aug. 28, 2003

Related U.S. Application Data
(63) Continuation-in-part of application No. 10/378,145, filed on Mar. 4, 2003.

(51) Int. Cl. A01D 46/00

(52) U.S. Cl. 56/328.1

(57) ABSTRACT

A produce harvesting and coring apparatus and method, which facilitates the harvesting and coring of produce in a field setting. In a preferred embodiment, a plurality of coring devices having automated coring elements are affixed to a side portion of an elongated harvesting apparatus, between work tables. A clean and core operator may then take an item of harvested produce and core it using the coring device, before placing the cored item of produce onto the elongated harvesting apparatus. The coring device preferably operates by placing an item of produce in a basket and moving the basket (with the produce therein) toward a rotating cutting element, permitting the cutting element to penetrate and remove the core of the item of produce.

### RELATED APPLICATION

This is a continuation-in-part of U.S. patent application Ser. No. 10/378,145, filed Mar. 4, 2003, and to which priority is claimed.

### BACKGROUND OF THE INVENTION

1. Field of Invention

This invention relates generally to apparatuses and methods for coring harvested produce and, more particularly, to an apparatus and method for coring harvested produce in a field setting.

2. Background of the Invention

The harvesting of certain types of produce, including for example varieties of cabbage, is typically accomplished manually. In a manual harvesting operation, a person (generally referred to as a “cutter”) will, using a special cutting tool, cut the produce head from the root portion, so that it may be removed from the ground. Where a mobile harvesting apparatus is utilized for further transport and/or processing of harvested produce, it may be the case that an additional worker will take the harvested produce, core it manually using a hand-held cutting tool, and place it on the harvesting apparatus. Alternatively, the produce may be harvested in the field but not cored, and then cored in a processing facility that is remote from the field.

There are several drawbacks with prior art methods. Where coring is accomplished manually in the field, that process can be relatively time consuming. Moreover, the use of a knife to perform the coring operation can result in injury to the person performing such an operation. On the other hand, where coring is conducted in a remote processing facility, the efficiency of performing the coring incident to the harvesting process and in the field setting is lost.

A need therefore existed for a harvesting apparatus that permits automated produce coring, in the field, in a manner that is safer than prior art fully manual methods. The present invention satisfies these needs and provides other, related, advantages.

### SUMMARY OF THE INVENTION

It is an object of the present invention to provide an improved apparatus and method for coring harvested produce in a field setting.

It is a further object of the present invention to provide an improved apparatus and method for coring harvested produce in a substantially automated way in a field setting.

### BRIEF DESCRIPTION OF THE PREFERRED EMBODIMENTS

In accordance with one embodiment of the present invention, a produce harvesting and coring apparatus is disclosed. The apparatus comprises, in combination: a harvesting apparatus; and at least one coring device having a powered coring element coupled to the harvesting apparatus.

In accordance with another embodiment of the present invention, a method for coring produce in a field setting is disclosed. The method comprises the steps of: providing a harvesting apparatus in a field to be harvested; providing at least one coring device having a powered coring element coupled to the harvesting apparatus; harvesting an item of produce from a field; and coring the item of produce on the at least one coring device while the harvesting apparatus is positioned in the field to be harvested.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a perspective view of an embodiment of a coring device consistent with the present invention.

FIG. 2 is a side view of the device of FIG. 1, illustrating the movement of the apparatus when a coring operation is performed.

FIG. 3 is a top view of the device of FIG. 1.

FIG. 4 is a perspective view of the cutting element of the device of FIG. 1.

FIG. 5 is a top view of an embodiment of a harvesting apparatus having a coring device thereon.

FIG. 6 is a side view of the harvesting apparatus of FIG. 5.

FIG. 7 is a perspective view of a cutting element for another embodiment of a coring device consistent with the present invention.

FIG. 8 is a top view of the cutting element of FIG. 7.

FIG. 9 is a perspective view of an embodiment of a coring device consistent with the present invention.

FIG. 10 is a side view of a mounting structure for an embodiment of a cording device consistent with the present invention.

FIG. 11 is a top view of the coring device of FIG. 9.

FIG. 12 is a side view of the cording device of FIG. 9.

### DETAILED DESCRIPTION OF THE PREFERRED EMBODIMENTS

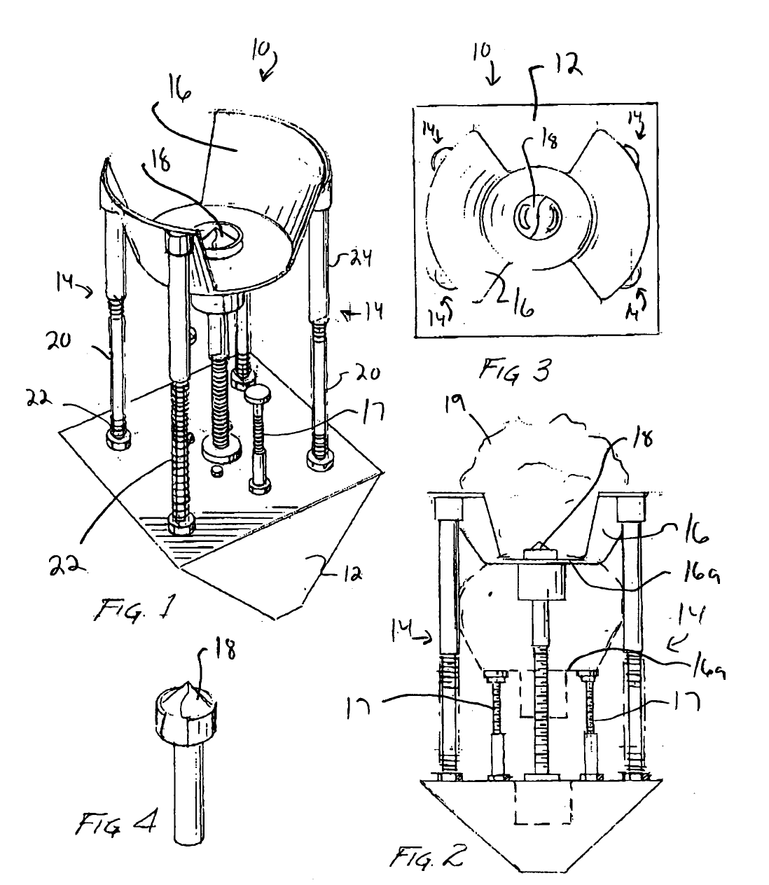

Referring to FIGS. 1-3, a coring device 10 is consistent with the present invention is shown. The coring device 10 preferably comprises a base portion 12, to which is affixed a plurality of spring-loaded supports 14. (While four supports 14 are shown, it should be understood that a greater or lesser number of supports 14 could be provided.) The supports 14 support a produce basket 16, having a coring bit 18 projecting through a bottom portion thereof. The produce basket 16 is dimensioned to receive an item of produce 19 therein. (Preferably, the item of produce 19 is cabbage, though other items of produce, such as lettuce, may also be cored with the coring device 10 of the present invention.) Below the basket 16 is positioned at least one and preferably two stops 17. The individual components and their operation will now be treated in greater detail.

Turning first to the spring-loaded supports 14, these preferably consist of a center post 20 which is coupled at a superior end thereof to the base portion 12. Over a lower portion of the center post 20 is positioned a spring 22. The topmost portion of the spring 22 contacts a sleeve 24, which is slidably retained on the center post 20 above the spring 22. Downward pressure on the sleeve 24 causes contraction of the spring 22, such that the release of such pressure will cause the sleeve 24 to move upward to its original position on the center post 20.

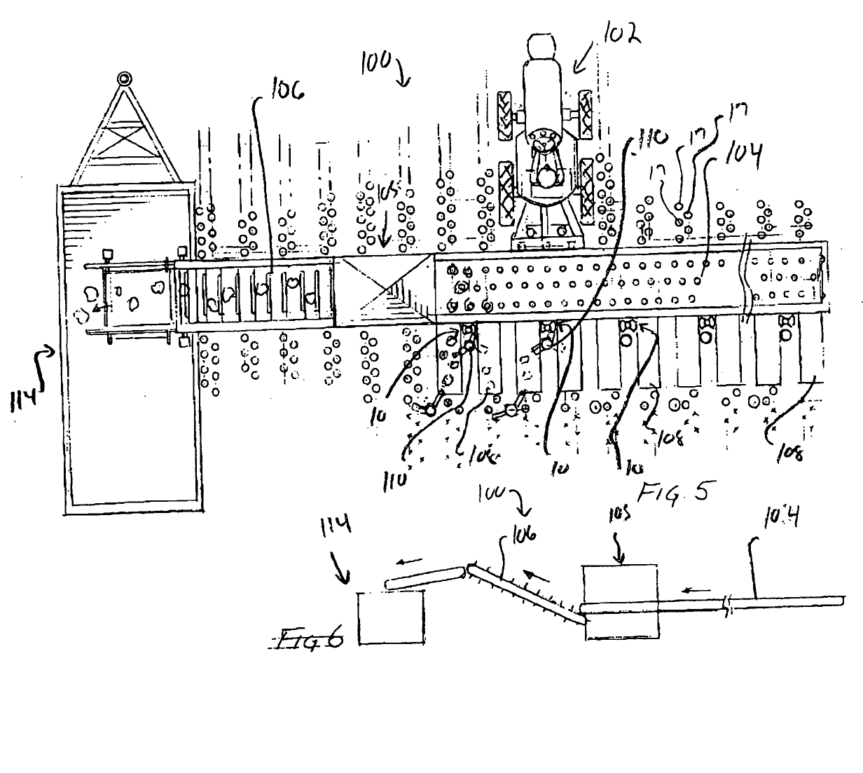

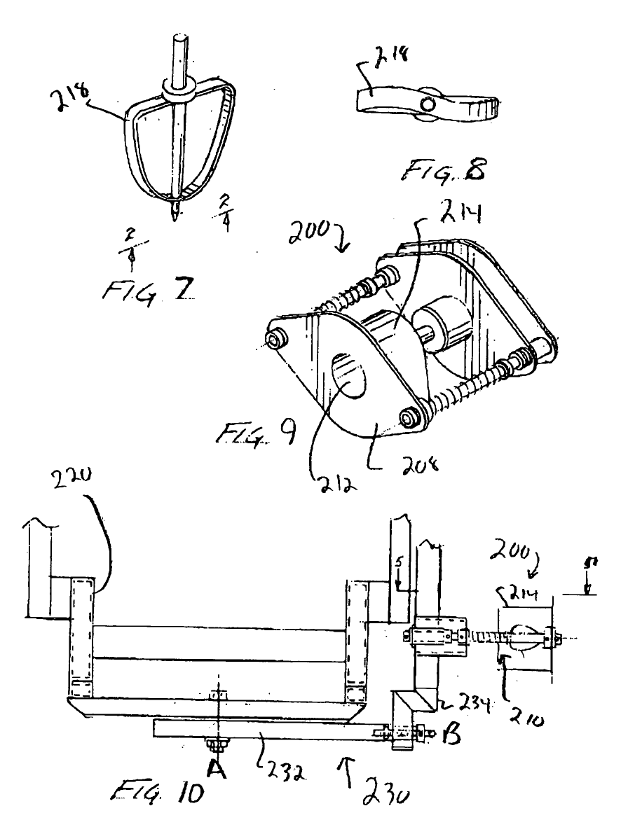

With specific regard to the stops 17, these preferably comprise upwardly extending posts that are adjustable in height. Such adjustability can be provided by, for example, providing a stop 17, as shown in FIGS. 1 and 2, in which a superior threaded shaft is received within a mating threaded shaft, such that rotation of the threaded shaft in one direction will increase the height of the stop 17, and rotation in the opposite direction will decrease its height.

Referring now to FIG. 4, attention is directed to the coring bit 18. The cording bit 18 projects through an opening in the base of the basket 16. While the length of the coring bit 18 may be adjustable, in operation, it remains of fixed length—so that depression of the basket 16 causes the position of the coring bit 18 to become raised relative to the base 16a of the basket 16, as illustrated in FIG. 2. The coring bit 18 comprises a cutting surface that is adapted to cut away the core of an item of produce 17, when the coring bit 18 is rotated and brought into contact with the produce 17 core. Rotational force is imparted through any desired automated means, with hydraulic power being preferred.

Referring now to FIGS. 5-6, a harvesting apparatus 100 having a plurality of coring devices 10 thereon is shown. The harvesting apparatus 100 is preferably towed by a trailer 102, though the harvesting apparatus 100 could be self-propelled. The harvesting apparatus 100 preferably comprises a horizontal conveyor 104, leading to an elevated conveyor 106.

Projecting outward from the horizontal conveyor 104 are a plurality of work tables 108. These work tables 108 should be spaced far enough apart to permit at least one clean and core person 110 to stand therebetween. The surface of the work tables 108, which are expected to come into contact with the harvested produce, should be stainless steel, for greater food safety. Coupled to the side of the apparatus 100, preferably between work tables 108, are coring devices 10.

As shown in FIG. 1, behind the clean and core persons 110 will preferably be a row of cutters 112. The role of the cutters 112 is to harvest the produce 17 from the ground, typically with a knife of some kind. After harvesting, the cutter 112 places the produce 17 on a work table 108 from where it can be taken by a clean and core person 110 or, optionally, hands it directly to a clean and core person 110.

The clean and core person 110 will then grasp the produce 17, place it into the basket 17 (as shown in FIG. 2), and press downward while the coring bit 18 is rotating (or with such downward force activating rotation of the coring bit 18). The clean and core operator 110 should continue to press down until the base 16a of the basket 16 contacts the stops 17.

Such downward motion of the basket 16 brings the core of the produce 17 into contact with the coring bit 18. Rotation of the coring bit 18 causes a cutting away of the core area of the produce 17, with the core being reduced to small pieces that fall into the basket 16. Because the basket 16 is preferably open on two sides (see FIGS. 1-3), the pieces fall through these openings and onto the ground.

It will be desired to adjust the height of the stops 17 so that, for the particular size of the produce 17 that is being harvested, the coring bit 18 will project sufficiently upward to remove the core, but not so high as to penetrate the exterior of the produce 17.

After coring, the clean and core operator 110 then removes the cored produce 17 from the basket 16, allowing the basket 16 to spring to its original position. The clean and core operator 110 then places the cored produce 17 on the horizontal conveyor 104. It will travel to the right (see FIG. 2) and may pass through an optional washing station 105. Thereafter, the produce 17 enters an elevated conveyor 106, from where it is ultimately loaded into a bin 114 or other desired loading location.

Refeerring now to FIGS. 7-9 and 11-12, another embodiment of a coring device, referred to as a coring device 200, is shown. The coring device 200 preferably comprises a first base plate 202, a second base plate 204, a pair of supports 206 having springs 207 therearound, a top plate 208, and a cutting element 210. With respect to the top plate 208, it has an opening 212 therethrough, which is dimensioned to permit the rotating cutting element 210 to pass therethrough without contacting the sides thereof.

Below the opening 212 and coupled to an underside of the top plate 208 is a reservoir 214. The reservoir 214 has an opening in an underside thereof (see FIG. 12) sufficient to permit at least a shaft portion 215 of the cutting element 210 to pass therethrough. The underside of the reservoir 214 is dimensioned to contact a base 216 of the cutting element 210 when the top plate 208 is depressed, as illustrated in FIG. 212.

As shown in FIGS. 7-8, the cutting element 210 includes an open blade 218. The blade 218 has a substantially egg beater type of configuration, and is preferably formed from stainless steel for food safety reasons. The blade 218 is preferably hydraulically powered.

In operation, a person will grasp an item of produce 17 (see FIG. 12), and position it on the top plate 208. The produce 17 should be positioned with the core down, and located over the opening 212. The person will depress the produce 17, causing the top plate 208 to travel in the direction of the second base plate 204. The springs 207 will resist this movement, with sufficient depressing force overcoming this resistance. Sufficient depression of the top plate 208 causes the rotating blade 218 to penetrate the opening 212 and cut away the core of the produce 17.

Contact between the underside of the reservoir 214 and the base 216 limits the extent of penetration of the blade 218 into the produce 17, limiting the risk that the blade 218 could fully penetate the produce 17 and potentially injure a worker. When the cutting operation is completed, the worker lifts the produce 17 off of the top plate 208. When the depressing force is removed, the springs 207, and top plate 208, will revert to their prior position.

It should be noted that it would be possible to adjust the position of the top plate 208 along the supports 206, so as to adjust the depth of the cut made by the blade 218.

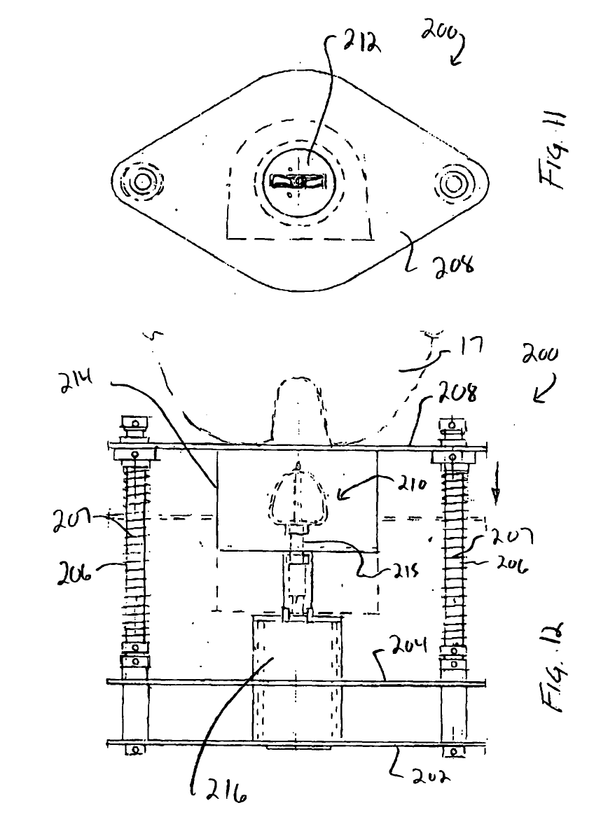

Attention is now directed to FIG. 10. While it would be possible to position the coring device 200 in a vertical configuration as shown in FIG. 12, so that, relative to the field, the top plate 208 is superior to the second base plate 204, a horizontal configuration is preferred. In this configuration, the coring device 200 projects outward in a horizontal orientatino from a harvesting apparatus 220. A primary benefit of this orientation is that it permits a worker to use his or her body weight to help in the action of depressing the produce 17, instead of requiring the worker to essentially fully rely on arm strength for this function. Additionally, this orientation is considered to reduce the risk of injury to the worker.

Still referring to FIG. 10, it is noted that a typical harvesting apparatus is regularly operated first on one side and, during a succeeding pass through the field, on its second side. One alternative would be to positioning coring devices 200 on both sides of the harvesting apparatus 220. Alternatively, it would be possible to swivel mount the coring device 200 to the harvesting apparatus 220, so that it may be swivelled from one side of the harvesting apparatus 220 to the other.

In this regard, it is preferred that the coring device be coupled to a mounting device 230. In one embodiment, the mounting device 230 preferably comprises a first arm 232 that is rotatably coupled in a horizontal plane to an underside of the harvesting apparatus 220 about point A, and a second arm 234 that is rotatably coupled in a vertical plane to first arm 232 about point B. In order to move the coring device 200 from a first side of the harvesting apparatus 220 to its second side, the second arm 234 will be rotated downward about point B, so as to position the coring device 200 below the level of the underside of the harvesting apparatus 220. The first arm 232 will then be rotated horizontally about point A, so as to position the coring device 200 on an opposite side of the harvesting apparatus 220. The second arm 234 will then be rotated upward about point B, so a to position the coring device 200 at the desired height level for coring operations. It can be seen through this description that an additional advantage to a horizontal orientation for the coring device 200 is that it reduces the clearance necessary to permit the coring device 200 to travel under the harvesting apparatus 220 from one side to the other.

While the invention has been particularly shown and described with reference to preferred embodiments thereof, it will be understood by those skilled in the art that the foregoing and other changes in form and details may be made therein without departing from the spirit and scope of the invention. For example, it should be noted that the coring process as outlined herein could be made more fully automated, by providing means for automatically depressing the basket 16 or top plate 208 when an item of produce 17 is positioned therein—so that it will not be necessary for a clean and core person 110 to manually depress the basket 16 or top plate 208. It may also be desired to provide a lid or other covering over the produce 17 when in position on the basket 16 or over the top plate 208, to maintain the produce 17 in a constant position and to reduce the risk that the coring bit 18 or blade 218 could come into contact with the hand of a person using the coring device 10 or 200.

I claim:

1. A produce harvesting and coring apparatus comprising, in combination:
a harvesting apparatus; and
at least one coring device having a powered coring element coupled to the harvesting apparatus.

2. The produce harvesting and coring apparatus of claim 1
wherein the harvesting apparatus is elongated, and includes a horizontal conveyor, and wherein the at least one automated coring device is coupled proximate a side of the horizontal conveyor.

3. The produce harvesting and coring apparatus of claim 2 further comprising a plurality of work tables projecting outward from a side of the horizontal conveyor, with the at least one automated coring device being located between two the work tables.

4. The produce harvesting and coring apparatus of claim 1 wherein the coring device comprises a basket supported by at least one spring-loaded support and having a coring bit adapted to project through an opening in a base of the basket.

5. The produce harvesting and coring apparatus of claim 4 wherein the basket has at least one open side to permit core cuttings to exit the basket.

6. The produce harvesting and coring apparatus of claim 5 wherein the basket has two said open sides.

7. The produce harvesting and coring apparatus of claim 4 further comprising at least one stop positioned below the base of the basket and adapted to limit downward motion of the basket.

8. The produce harvesting and coring apparatus of claim 7 comprising two said stops.

9. The produce harvesting and coring appartus of claim 7
wherein a height of the at least one stop is adjustable.

10. The produce harvesting and coring apparatus of claim 1 wherein the coring device comprises a top plate supported by at least one spring-loaded support and having an open blade adapted to project through an opening in said top plate.

11. The produce harvesting and coring apparatus of claim 10 further comprising means for limiting downward motion of the top plate.

12. The produce harvesting and coring apparatus of claim 11 wherein said means comprises two said stops.

13. The produce harvesting and coring apparatus of claim 1, further comprising means for moving a single said coring device from a first side of said harvesting apparatus to a second side of said harvesting apparatus.

14. The produce harvesting and coring apparatus of claim 1 wherein said moving means comprises a mounting device coupled to said coring device, wherein said mounting device comprises, in combination:
a first arm rotatably coupled in a horizontal plane to an underside of said harvesting apparatus; and
a second arm rotatably coupled in a vertical plane to said first arm;
wherein said second arm is coupled to said coring device.

15. A method for coring produce in a field setting comprising the steps of:
providing a harvesting apparatus in a field to be harvested;
providing at least one coring device having a powered coring element coupled to the harvesting apparatus;
harvesting an item of produce from a field; and
coring the item of produce on the at least one coring device while the harvesting apparatus is positioned in the field to be harvested.

16. The method of claim 15 wherein the harvesting apparatus is elongated, and includes a horizontal conveyor, and wherein the at least one automated coring device is coupled proximate a side of the horizontal conveyor.

17. The method of claim 16 further comprising the step of providing a plurality of work tables projecting outward from a side of the horizontal conveyor, with the at least one automated coring device being located between two the work tables.

18. The method of claim 15 wherein the coring device comprises a basket supported by at least one spring-loaded support and having a coring bit adapted to project through an opening in a base of the basket.

19. The method of claim 18 wherein the basket has at least one open side to permit core cuttings to exit the basket.

20. The method of claim 19 wherein the basket has two said open sides.

21. The method of claim 18 further comprising at least one stop positioned below the base of the basket and adapted to limit downward motion of the basket.

22. The method of claim 21 comprising two said stops.

23. The method of 21 wherein a height of the at least one stop is adjustable.

24. The method of claim 18 further comprising the steps of:
placing the item of produce in the basket;
moving the basket in a direction of said coring element;
the coring element coring the item of produce;
removing the item of produce from the basket; and
the basket moving in away from said coring element.

25. The method of claim 15 further comprising the steps of:
providing means for moving a single said coring device from a first side of said harvesting apparatus to a second side of said harvesting apparatus; and
moving said single coring device from said first side of said harvesting apparatus to said second side of said coring device.

26. The method of claim 25 wherein said step of providing moving means comprises the steps of:
providing a first arm rotatably coupled in a horizontal plane to an underside of said harvesting apparatus; and
providing a second arm rotatably coupled in a vertical plane to said first arm;
wherein said second arm is coupled to said coring device.
